(19) United States
(12) Patent Application Publication
(10) Pub. No.: US 2023/0108735 A1
(43) Pub. Date: Apr. 6, 2023

(54) A SHAVING APPARATUS HAVING A COLLECTION CHAMBER

(71) Applicant: HYBRID RAZOR LTD., Haifa (IL)

(72) Inventors: Shoam ZAK, Givat Ela (IL); Shai BRENNER, Haifa (IL)

(21) Appl. No.: 17/911,209

(22) PCT Filed: Mar. 15, 2021
(86) PCT No.: PCT/IL2021/050281

§ 371 Date: Sep. 13, 2022

Related U.S. Application Data
(60) Provisional application No. 62/991,868, filed on Mar. 19, 2020.

(51) Int. Cl. B26B 19/16; B26B 19/38

(52) U.S. Cl. CPC B26B 19/16; B26B 19/386

(57) ABSTRACT

Provided herein is a shaving apparatus capable of collecting cut hair, the apparatus includes a head shaving portion that includes a cutting portion having a cylindrical screen comprising a plurality of openings, an outer surface and an inner surface defining an inner cavity; a cutting component comprising one or more cutting elements, the cutting component positioned adjacent to the inner surface of the cylindrical screen to cut hairs that pass through the openings in the screen; and an inner cradle positioned within the inner cavity, the inner cradle is configured to collect cut hair.

### FIELD OF THE INVENTION

The present invention generally relates to a shaving apparatus having a collection chamber for cut hairs, as well as to methods of using the same for removal of hair from a skin region.

### BACKGROUND OF THE INVENTION

Methods for removing hair from skin surface, by shaving (i.e., cutting of the hair rather than pulling the hair (such as in epilation)), include the razor blade approach, where a very sharp blade is pushed against the skin at an angle, thereby cutting hair; and the screen approach, wherein a thin fenestrated metal screen is moved across the skin, exposing hair though the holes and cutting them by a mechanized, typically motorized, cutting element. There are several different types of devices used to shave body hair. These include disposable razors, electric razors, cartridge razors, safety razors, and straight razors. Electric razors also come in different types, including foil-style electric razors and rotary-style electric razors. In a foil-style electric razor, a thin, perforated, protective metal screen is provided, which covers the blades. The blades are sharp reciprocating or oscillating blades that move side-to-side at very high speed behind the protective metal screen. The user's hairs pass through openings in the protective metal screen (which is stationary) and are then cut as the blades oscillate back and forth. In a rotary-style electric razor, there are several circular screens that have an internally spinning cutter blade that cuts the hairs captured by the stationary circular screens.

However, the shaving operation involves the accumulation of cut hair, which may pose, inter alia, health, hygienic and functional issues when using shaving apparatuses, and in particular, shaving apparatus which use a closed cylinder.

Thus, there is a need in the art for improved shaving apparatus, in particular of a cylinder type shaving apparatus, that allows an efficient, safe and hygienic collection of cut hair and removal thereof from the shaving apparatus.

### SUMMARY OF THE INVENTION

According to some embodiments, there is provided an advantageous shaving apparatus having a handle portion and a head portion, wherein the head portion includes a cutting portion, which includes a cylindrical screen having a plurality of openings, an outer surface and an inner surface defining an inner cavity; a cutting component comprising one or more cutting elements, which is positioned adjacent to the inner surface of the cylindrical screen, to cut hairs that pass through the openings in the cylindrical screen and an inner cradle, which is positioned within the inner cavity, wherein the inner cradle is configured to collect cut hair and to optionally further distribute the collected hair to a dedicated collection chamber, in safe, efficient and clean manner.

Thus, the disclosed having apparatus, and in particular, the advantageous cutting portion thereof allows for a very efficient collection of cut hair, without affecting mechanical operation of the apparatus and without posing hygienic concerns.

According to some embodiments, advantageously, the shaving apparatus disclosed herein includes a hair collection chamber, allowing close and comfortable shaving.

According to some embodiments, the present invention is directed to a shaving apparatus having a head portion including a cutting portion intended for contact with a skin surface to cut hairs growing therefrom. The cutting portion may include a cylindrical screen and a cutting component located beneath the screen. The screen may include a plurality of openings so that a user's hairs can pass therethrough to be cut by blades of the cutting component and the cut hair may be collected in the inner cavity on a suitable cradle.

According to some embodiments, the cut hair may be collected within the inner cavity (i.e. on the inner cradle) of the cutting portion, which may be disposable and replaceable, for example, when filled with cut hair.

In some embodiments, the cut hair may be temporarily collected/accumulated within the inner cavity and further evacuated/cleared/moved from the inner cavity (by the cradle) towards collection chambers, as detailed hereinbelow.

According to some embodiments, there is provided a head portion of a shaving apparatus, the head portion includes a cutting portion, the cutting portion includes: a cylindrical screen having a plurality of openings, an outer surface and an inner surface defining an inner cavity; a cutting component having one or more cutting elements, the cutting component is positioned adjacent to the inner surface of the cylindrical screen to cut hairs that pass through the openings in the screen; and an inner cradle positioned within the inner cavity and facing an inner surface of the cutting component, wherein the inner cradle is configured to collect cut hair.

According to some embodiments, the head portion may further include two end elements having one or more apertures on a face thereof, said end elements are positioned perpendicularly to the cylindrical screen, at each end thereof.

According to some embodiments, the end elements are substantially round. In some embodiments, the end elements may be essentially similar thereto, in size, shape and/or composition.

In some embodiments, the end elements may be in the form of a wheel comprising one or more apertures, whereby the one or more apertures allow the movement or clearance/removal/evacuation of the cut hair from the cradle in the inner cavity of the cylindrical screen outside of the inner cavity.

According to some embodiments the cylindrical screen may be rotatable around a rotational axis.

According to some embodiments, the cylindrical screen may be a foil screen. According to some embodiments, the cylindrical screen may be made of aluminum.

According to some embodiments, the openings of the cylindrical screen are cutting edge openings.

According to some embodiments, the cutting portion includes a gap between the end elements and the cutting component.

According to some embodiments, the cutting component may include a curved/folded cutting foil.

According to some embodiments, the curved cutting foil may be made of aluminum.

According to some embodiments, the cutting component may include a plurality of semi-round slice cutter elements having a space therebetween.

According to some embodiments, the cutting component may be configured to oscillate/move along a linear axis to facilitate cutting of the hairs by the cutting elements.

According to some embodiments, the cradle may be rigid or semi rigid.

According to some embodiments, the cradle may be made of plastic, metal, rubber, or combinations thereof.

According to some embodiments, the inner cradle and the cutting component move or oscillate along a linear axis in a synchronous manner, thereby facilitating movement of the cut hair towards the ends of the cradle.

According to some embodiments, the head portion may further include a mounting portion, wherein the cutting portion is configured to be mounted or placed onto said mounting portion.

According to some embodiments, the mounting portion comprises one or more collection chamber openings configured to receive cut hair from the ends of the inner cradle.

According to some embodiments, the cutting portion and/or the mounting portion are disposable.

According to some embodiments, there is provided a shaving apparatus which includes a handle portion and the head portion disclosed herein.

According to some embodiments, the shaving apparatus may further include a motor and a power source.

According to some embodiments, the head portion may be configured to be reversibly mounted/placed/attached on the handle portion.

According to some embodiments, the head portion may be disposable.

According to some embodiments, there is provided a method of shaving a skin surface, the method includes: pressing a head portion of a shaving apparatus onto a skin surface, said head portion has a cutting portion, the cutting portion includes a cylindrical screen having a plurality of openings, an outer surface and an inner surface defining an inner cavity; a cutting component comprising one or more cutting elements, the cutting component positioned adjacent to the inner surface of the cylindrical screen to cut hairs that pass through the openings in the screen; and an inner cradle positioned within the inner cavity and facing an inner surface of the cutting component, said inner cradle is configured to collect cut hair, such that cut hair is collected in the inner cradle and optionally moved or cleared therefrom to a collection chamber.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE DRAWINGS

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not to scale. In the Figures:

FIGS. 1A-1D—schematic illustrations of perspective views of components and elements of a cutting portion of a shaving apparatus, according to some embodiments. FIG. 1A—showing a cylindrical screen and end elements of the cutting portion; FIG. 1B—showing a cutting component, cradle wall and end elements of the cutting portion; FIG. 1C—showing a cutting component, cradle wall and inner cavity of the cutting portion; FIG. 1D—showing a side view of cutting component, and cradle of the cutting portion.

FIGS. 2A-B—schematic views of a components of a head portion of a shaving apparatus, according to some embodiments. FIG. 2A shows a schematic view of a mounting portion of a head portion; FIG. 2B shows a schematic view of a mounting portion of a head portion having a cutting portion mounted thereto;

FIG. 2C shows a schematic frontal view of a cross section of a head portion of a shaving apparatus, according to some embodiments;

FIGS. 3A-3D—schematic illustrations of perspective views of components and elements of a cutting portion of a shaving apparatus, according to some embodiments. FIG. 3A—showing a cylindrical screen and end elements of the cutting portion; FIG. 3B—showing a cutting component, cradle wall and end elements of the cutting portion; FIG. 3C—showing a cutting component, cradle wall and inner cavity of the cutting portion; FIG. 3D—showing a side view of cutting component, and cradle of the cutting portion;

FIGS. 4A-B—schematic views of a components of a head portion of a shaving apparatus, according to some embodiments. FIG. 4A shows a schematic view of a mounting portion of a head portion; FIG. 4B shows a schematic view of a mounting portion of a head portion having a cutting portion mounted thereto;

FIG. 4C shows a schematic frontal view of a cross section of a head portion of a shaving apparatus, according to some embodiments.

### DETAILED DESCRIPTION OF THE INVENTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the following description, various aspects of the invention will be described. For the purpose of explanation, specific details are set forth in order to provide a thorough understanding of the invention. However, it will also be apparent to one skilled in the art that the invention may be practiced without specific details being presented herein. Furthermore, well-known features may be omitted or simplified in order not to obscure the invention.

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description.

The embodiments provided herein are directed to components/portions of a head portion of a shaving apparatus. A typical shaving apparatus of the present invention has a handle portion that enables a user to grip the shaving apparatus during shaving operations, a power supply, and a motor to enable the shaving apparatus to function. Also included is an optional a user interface. Parts of the head portion may be detachable from the handle portion so that it may be replaced when it no longer provides the desired cutting performance, or for emptying or disposing of cut hair accumulated in collection chambers, as detailed herein.

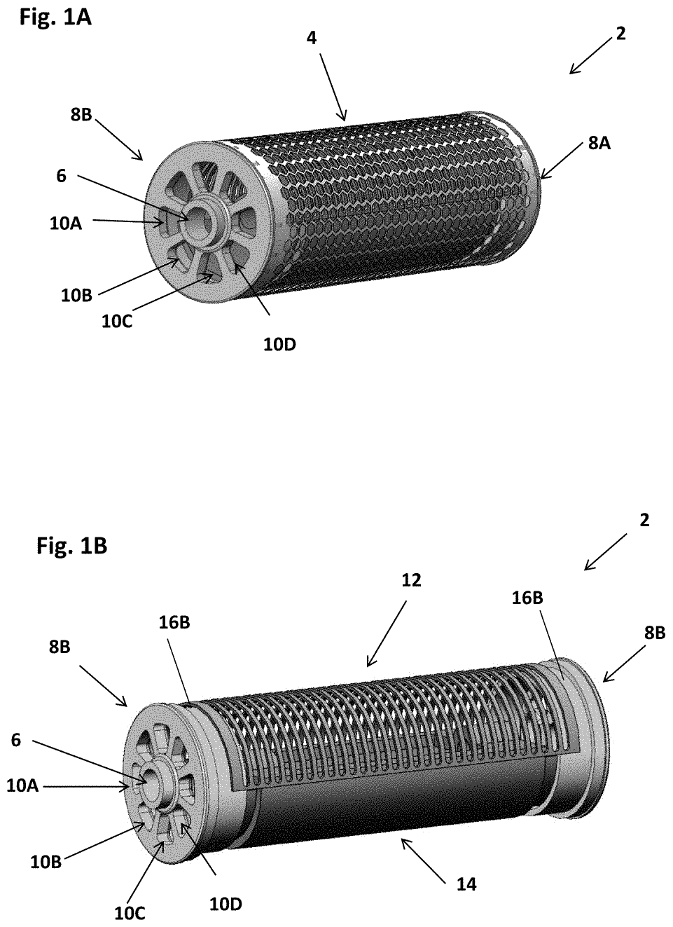

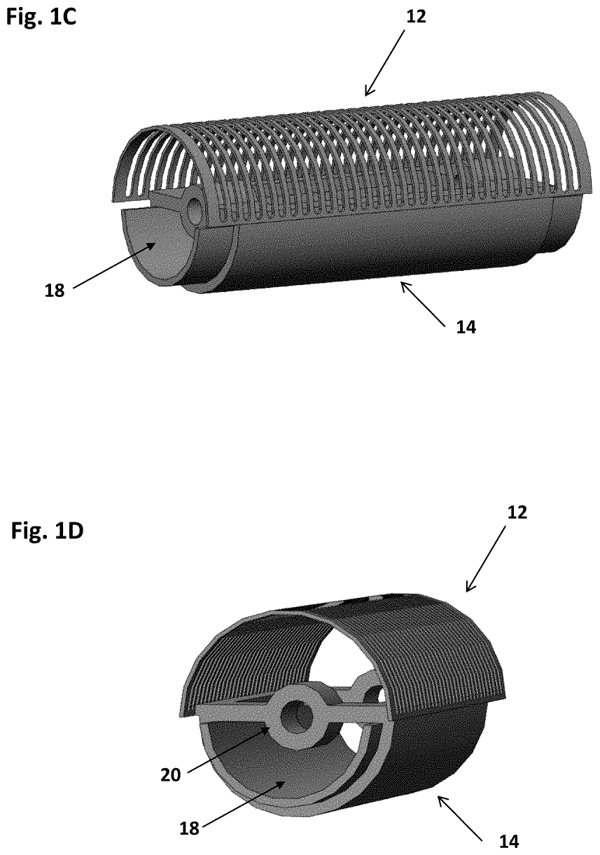

Reference is now made to FIGS. 1A-B, illustrating a cutting portion of a head portion of a shaving apparatus, according to some embodiments. As shown in FIG. 1A, the cutting portion 2, includes a cylindrical screen (4) having openings/apertures on the external surface thereof. The apertures are shown in FIG. 1A as a lattice of apertures. The openings (apertures) can generally have any desired geometrical shape. In some embodiments, the apertures can at least partially function as cutting edges of hairs introduced through the apertures. In some embodiments, the cylindrical screen is elongated along an axis. Further shown in FIG. 1A are end elements 8A and 8B, which are placed at the ends of the cylindrical screen, to essentially form a cylinder. The end elements may have any suitable shape. In some embodiments, the end elements are round or circular and conform to the diameter of the cylinder defined by the cylindrical screen. The end elements may be identical, similar or different with respect to their size, shape, form and/or compositions. The end elements may have one or more openings on their face. For example, central opening 6 is shown, which may be used to aid in the positioning and/or functioning of the cutting portion, for example, by being mounted on or attached to suitable hinges, allowing the rotation of the cutting portion. The end elements further include openings/apertures located more distally to the center of the end elements, i.e., closer to the circumference of the end elements. Shown in FIG. 1A are exemplary openings 10A-D located closer to the external circumference of the end elements. The openings are placed radially on the end face of the end elements. The openings on the face of the end elements may have any suitable and desired geometrical shape. The openings may be similar, identical or different with respect to size, shape and/or distribution. Such openings on the face of the end elements may be used, inter alia, to allow or facilitate clearance/movement/evacuation of cut hair which has been collected/accumulated within the internal cavity of the cutting portion.

Reference is now made to FIG. 1B which illustrates the cutting portion shown in FIG. 1A, with the external cylindrical screen (4 in FIG. 1A), removed. As shown in FIG. 1B, the cutting portion 2, has a cutting component 12, shown as folded cutting foil, having a curved shape, configured to fit within the cavity formed by the cylindrical screen. The cutting element includes a plurality of cutting elements having edges/blades spaced therebetween and forming a single cutting component. The folded cutting foil is configured to allow cutting of hair, protruding between the apertures of the external cylindrical screen and the cutting elements. Further shown in FIG. 1B are the end elements 8A and 8B, which are placed at the ends of the cylindrical screen and are in contact with the edges of the foil cutter. As shown in FIG. 1B, a gap (space) 16A and 16B is formed between the surface of the end elements (8A and 8B) and the respective ends of the cutting component 12. In some embodiments, the gap may be in the length of about 0.5-5 mm on each side. In some exemplary embodiments, the gap (16A and 16B) is about 1.5 mm on each side. In some embodiments, the gaps 16A and 16B are equal. In some embodiments, the gaps 16A-16B are different. Further shown in FIG. 1B is the external wall 14 of an internal cradle, forming a concaved cavity within the cutting portion, capable of collecting cut hair, after it has been cut by the cutting component, the external cylindrical screen and/or the interface therebetween. In some embodiments, the cradle may integrally form with the cutting components. In some embodiments, the cradle may be functionally or physically attach/associate with the cutting component. In some embodiments, as detailed below, the cradle and the cutting component may move together, synchronously. In some embodiments, the cradle and the cutting component may move or oscillate sideways, in a linear motion. In some embodiments, the cradle may be rigid, semi rigid or soft. In some embodiments, the cradle may be made of plastic, rubber, metal, or any combination thereof.

Reference is now made to FIG. 1C which illustrates a frontal perspective view of the cutting portion shown in FIG. 1A, with the external cylindrical screen (4 in FIG. 1A) and the end elements (8A-B in FIG. 1A) removed. As shown in FIG. 1C, the cutting portion 2, has a cutting component 12, shown as folded cutting foil, having a curved shape, configured to fit within the cavity formed by the cylindrical screen. The cutting element includes a plurality of cutting elements having edges/blades spaced therebetween and forming a single cutting component. The folded cutting foil is configured to allow cutting of hair, protruding between the apertures of the external cylindrical screen and the cutting elements. Further shown in FIG. 1C is the external wall 14 of an internal cradle, forming a concaved cavity (18) within the cutting portion, capable of collecting (and/or storing/holding) cut hair, after it has been cut by the cutting component, the external cylindrical screen and/or the interface therebetween.

FIG. 1D illustrates a side view of the cutting portion shown in FIG. 1C. As shown in FIG. 1D, the cutting component 12 has a convex (dome-like) shape, forming an internal cavity 18, together with cradle 14. By this setting, the cradle is configured to collect cut hair and to optionally further dispense/remove the accumulated cut hair from the cradle to an external location, such as an external collection chamber, as further detailed below. Further shown in FIG. 1D is mounting element 20, configured to aid in mounting/placing the cutting portion on a suitable mounting portion, for example, by attaching to a suitable hinge or axis, and to optionally further facilitate operation of the cutting portion.

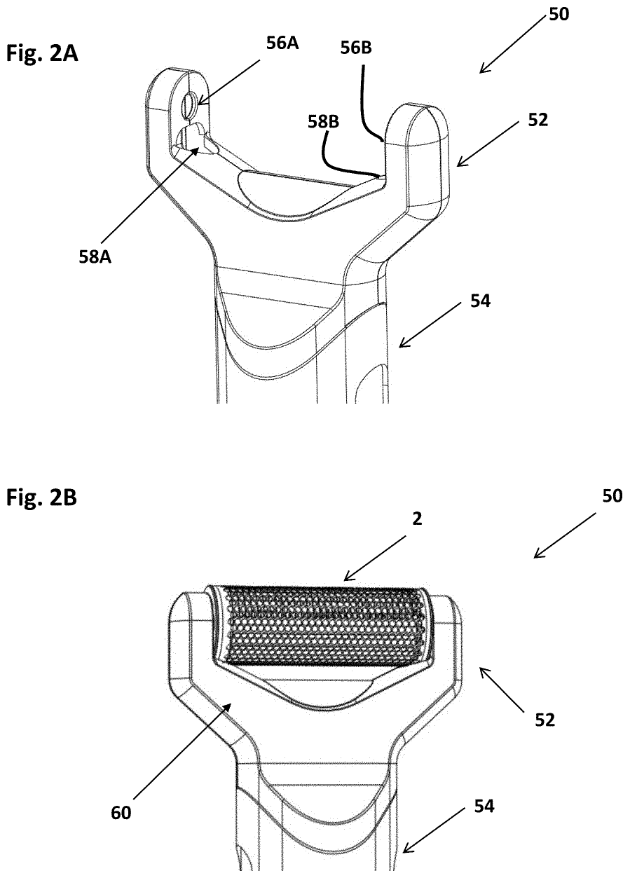

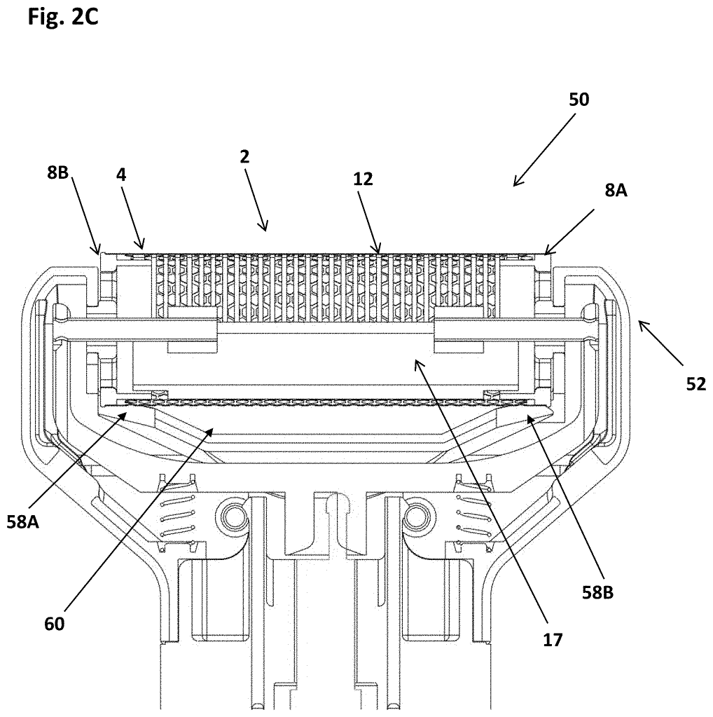

Reference is now made to FIG. 2A which shows a schematic illustration of a mounting portion 52, of a head portion 50 of a shaving apparatus, according to some embodiments. As shown in FIG. 2A, the mounting portion 52 includes grooves, such as, grooves 56A-B, configured to allow the connection/mounting of a cutting portion. Further, mounting element 52 includes collection chamber opening 58A and 58B, which are configured to facilitate the collection of cut hair removed/collected/evacuated from the cutting component, in particular from the cradle cavity region within the cutting component. In some embodiments, as detailed below, cut hair accumulated within the cavity of the cutting portion, i.e., on the cradle, is constantly moved to the sides of the cradle, by the linear sideways movement of the cradle together with the cutting component, within the cutting portion, to allow evacuation/exit of the cut hair, via the apertures on the face of the end elements, towards the collection chamber openings 58A and 58B. The hair passing through the collection chamber openings may then accumulate in a dedicated collection chamber within the mounting portion 52 and/or within the handle portion 54 of the shaving apparatus.

Reference is now made to FIG. 2B which shows a schematic illustration of a mounting portion 52, of a head portion 50 of a shaving apparatus, along with a cutting portion, 2, mounted/placed/attached thereto, according to some embodiments. As shown in FIG. 2B, the mounting portion 52 holds the cutting portion, while allowing the cutting portion to rotate along a linear axis. Further, mounting element 52 includes a collection chamber 60, which is in connection with the chamber openings (58A and 58B in FIG. 2A). The collection chamber is configured to collect/hold/store cut hair. In some embodiments, the collection chamber may additionally or alternatively be placed in the handle portion of the shaving apparatus.

Reference is now made to FIG. 2C, which shows a cross section of a front view of a head portion of a shaving apparatus, according to some embodiments. As shown in FIG. 2C, head portion 50 includes mounting portion 52, onto which cutting portion 2 is attached/mounted. Further shown is the inner surface (having apertures) of cylindrical screen 4, and the blades of cutting component (cutting foil) 12, as well as internal cradle wall 17. Also shown are end elements 8A-8B, which aid in the placement of the cutting portion onto the mounting portion, using suitable hinges and grooves that facilitate positioning and operation of the cutting portion (i.e., allow correct placement, allow rotation of the cylindrical screen, allow liner movement of the cutting component and/or the cradle, and the like). Further shown are collection chamber openings 58A and 58B, which are configured to facilitate the collection of cut hair removed/collected/evacuated from the cutting component, in particular from the cradle cavity region within the cutting component, for example, via suitable apertures on the end face of end elements 8A-B. In some embodiments, cut hair which accumulates within the cavity of the cutting portion, i.e., on the cradle, is constantly moved to the sides of the cradle, by the linear sideways movement of the cradle together with the cutting component, within the cutting portion, to allow evacuation/exit of the cut hair, via the apertures on the face of the end elements, towards the collection chamber openings 58A and 58B. The hair passing through the collection chamber openings may then accumulate in a dedicated collection chamber (60) within the mounting portion 52 and/or within the handle portion 54 of the shaving apparatus.

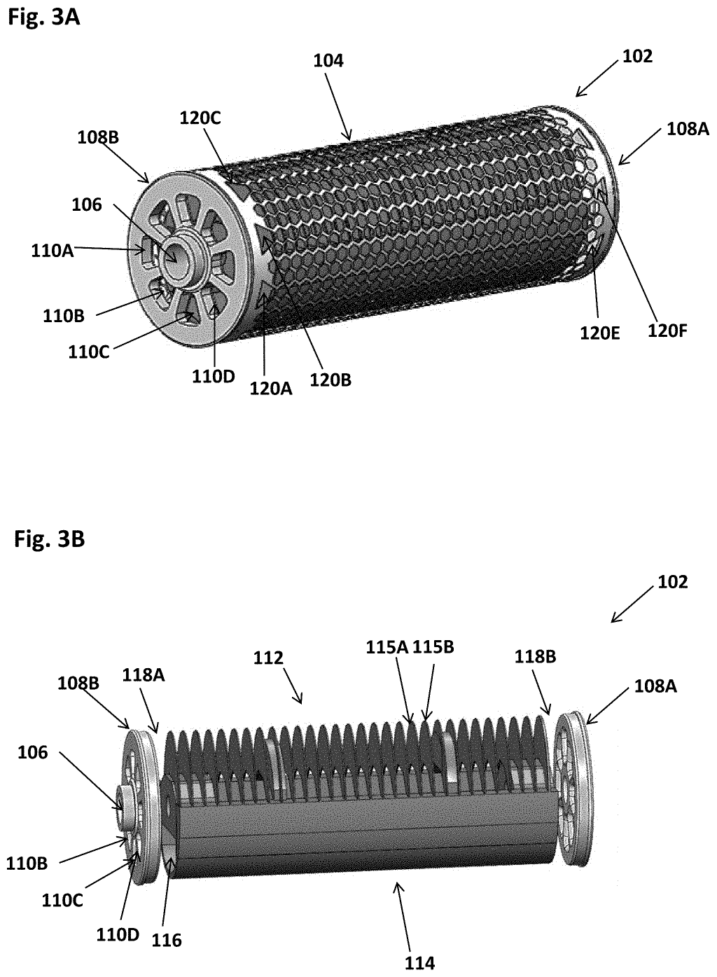

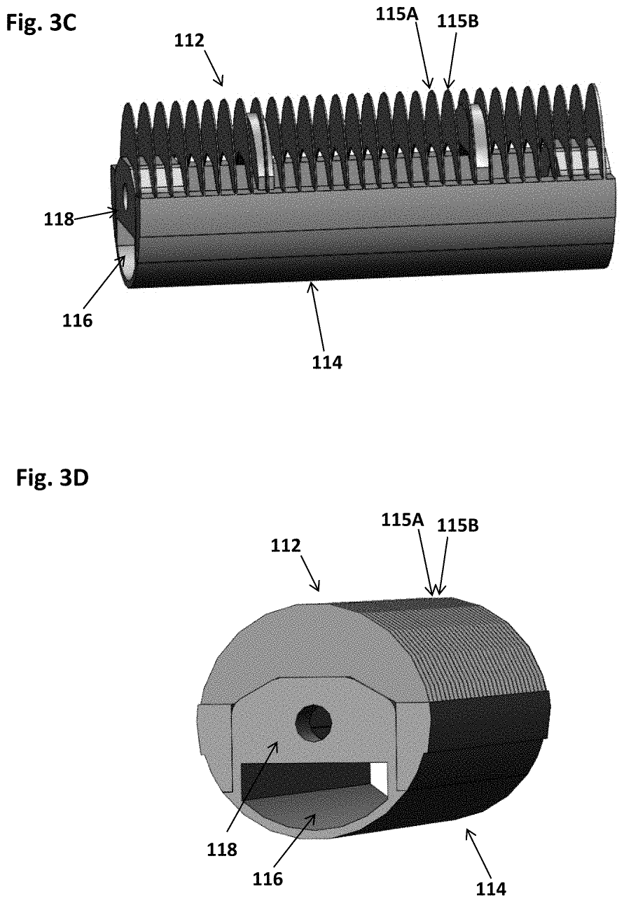

Reference is now made to FIGS. 3A-B, illustrating a cutting portion of a head portion of a shaving apparatus, according to some embodiments. As shown in FIG. 3A, the cutting portion 102 includes a cylindrical screen (104) having openings/apertures on the external surface thereof. The apertures are shown in FIG. 3A as a lattice of apertures. The openings (apertures) can generally have any desired geometrical shape. In some embodiments, the apertures can at least partially function as cutting edges of hairs introduced through the apertures. In some embodiments, the cylindrical screen is elongated along an axis. In some embodiments, the cylindrical screen may further include, at the ends thereof, additional apertures having a similar or different shape, allowing the removal of cut hair from the cutting portion, as further detailed below. In FIG. 3A, such additional removal apertures are shown as exemplary triangular apertures 120A-F. Further shown in FIG. 3A are end elements 108A and 108B, which are placed at the ends of the cylindrical screen, to essentially form a cylinder. The end elements may have any suitable shape. In some embodiments, the end elements are round or circular and conform to the diameter of the cylinder defined by the cylindrical screen. The end elements may be identical, similar or different with respect to their size, shape, form and/or compositions. The end elements may have one or more openings on their face. For example, central opening 106 is shown, which may be used to aid in the positioning and/or functioning of the cutting portion, for example, by being mounted on or attached to suitable hinges, allowing the rotation of the cutting portion. The end elements further include openings/apertures located more distally to the center of the end elements, i.e., closer to the circumference of the end elements. Shown in FIG. 3A are exemplary openings 110A-D located closer to the external circumference of the end elements. The openings are placed radially on the end face of the end elements. The openings on the face of the end elements may have any suitable and desired geometrical shape. The openings may be similar, identical or different with respect to size, shape and/or distribution. Such openings on the face of the end elements may be used, inter alia, to allow or facilitate clearance/movement/evacuation of cut hair which has been collected/accumulated within the internal cavity of the cutting portion.

Reference is now made to FIG. 3B which illustrates the cutting portion shown in FIG. 3A, with the external cylindrical screen (104 in FIG. 3A), removed. As shown in FIG. 3B, the cutting portion 102, has a cutting component 112, having a plurality of separated cutting blades (exemplary blades 115A-B are marked), having a curved shape, configured to fit within the cavity formed by the cylindrical screen. The plurality of cutting elements (blades) are spaced therebetween. The cutting component having the cutting blades is configured to allow cutting of hair, protruding between the apertures of the external cylindrical screen and the cutting elements (blades). Further shown in FIG. 3B are the end elements 108A and 108B, which are placed at the ends of the cylindrical screen. As shown in FIG. 3B, a gap (space) 118A and 118B is formed between the surface of the end elements (108A and 108B) and the respective ends of the cutting component 112. In some embodiments, the gap may be in the length of about 0.5-5 mm on each side. In some exemplary embodiments, the gap is about 1.5 mm on each side. In some embodiments, the gaps 118A and 118B are equal. In some embodiments, the gaps 18A-18B are different. In some embodiments, the end apertures of the cylindrical screen (exemplary apertures 120A-F shown in FIG. 3A) are placed essentially above/around gaps 18A and/or 18B. Further shown in FIG. 3B is the external wall 114 of an internal cradle, forming a concaved cavity within the cutting portion, capable of collecting cut hair, after it has been cut by the cutting component, the external cylindrical screen and/or the interface therebetween. In some embodiments, the cradle may integrally form with the cutting components. In some embodiments, the cradle may be functionally or physically attach/associate with the cutting component. In some embodiments, the cradle and the cutting component may move together, synchronously. In some embodiments, the cradle and the cutting component may move or oscillate sideways, in a linear motion. In some embodiments, the cradle may be rigid, semi rigid or soft. In some embodiments, the cradle may be made of plastic, rubber, metal, or any combination thereof.

Reference is now made to FIG. 3C which illustrates a frontal perspective view of the cutting portion shown in FIG. 3A, with the external cylindrical screen (104 in FIG. 3A) and the end elements (108A-B in FIG. 3A) removed. As shown in FIG. 3C, the cutting portion 102, has a cutting component 112, having a plurality of separated cutting blades (exemplary blades 115A-B are marked), having a curved shape, configured to fit within the cavity formed by the cylindrical screen. The plurality of cutting elements (blades) are spaced therebetween. The cutting component having the cutting blades is configured to allow cutting of hair, protruding between the apertures of the external cylindrical screen and the cutting elements (blades). Further shown in FIG. 3C is the external wall 114 of an internal cradle, forming a concaved cavity (116) within the cutting portion, capable of collecting (and/or storing/holding) cut hair, after it has been cut by the cutting component, the external cylindrical screen and/or the interface therebetween. Further shown is mounting element 118, located at each end of the internal cavity, designed to facilitate the mounting/placement and/or operation of the cutting portion.

Reference is made to FIG. 3D, which illustrates a side view of the cutting portion shown in FIG. 3C. As shown in FIG. 3D, the cutting component 112 has a convex (dome-like) shape, forming an internal cavity 116, together with cradle 114. By this setting, the cradle is configured to collect cut hair and to optionally further dispense/remove the accumulated cut hair from the cradle to an external location, such as an external collection chamber, as further detailed below. Further shown in FIG. 3D is mounting element 118, configured to aid in mounting/placing the cutting portion on a suitable mounting portion, for example, by attaching to a suitable hinge or axis and to optionally further facilitate operation of the cutting portion.

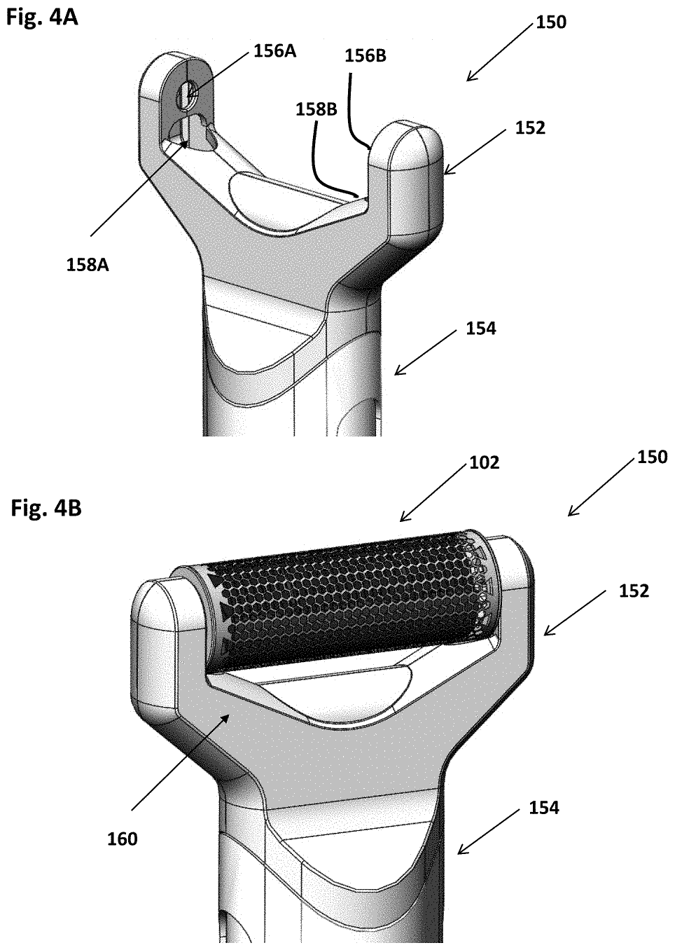

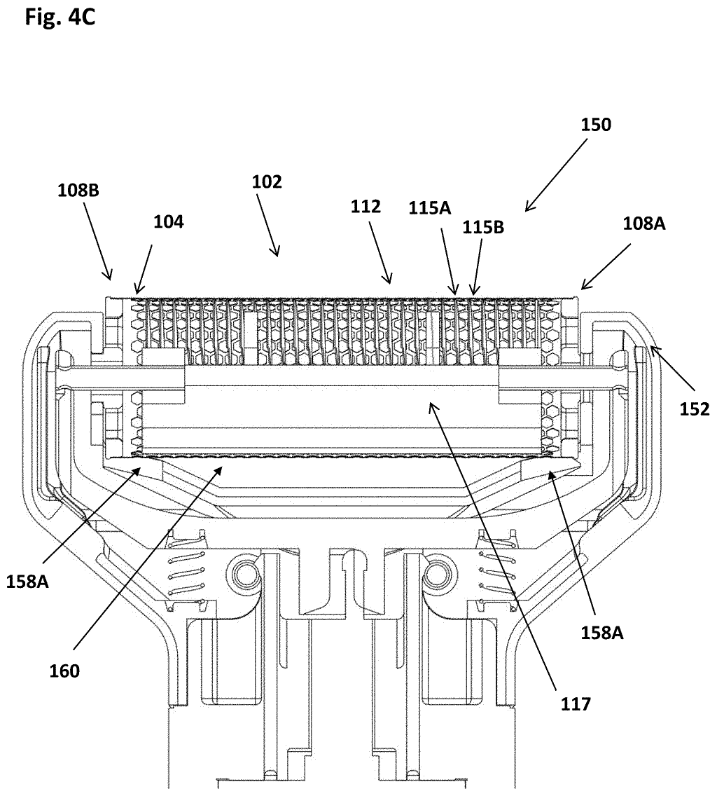

Reference is now made to FIG. 4A which shows a schematic illustration of a mounting portion 152, of a head portion 150 of a shaving apparatus, according to some embodiments. As shown in FIG. 4A, the mounting portion 152 includes grooves, such as, grooves 156A-B, configured to allow the connection/mounting of a cutting portion. Further, mounting element 152 includes collection chamber opening 158A and 158B, which are configured to facilitate the collection of cut hair removed/collected/evacuated from the cutting component, in particular from the cradle cavity region within the cutting component. In some embodiments, as detailed below, cut hair accumulated within the cavity of the cutting portion, i.e., on the cradle, is constantly moved to the sides of the cradle, by the linear sideways movement of the cradle together with the cutting component, within the cutting portion, to allow evacuation/exit of the cut hair, via the apertures on the face of the end elements, towards the collection chamber openings 158A and 158B. The hair passing through the collection chamber openings may then accumulate in a dedicated collection chamber within the mounting portion 52 and/or within the handle portion 154 of the shaving apparatus.

Reference is now made to FIG. 4B which shows a schematic illustration of a mounting portion 152, of a head portion 150 of a shaving apparatus, along with a cutting portion, 102, mounted/placed/attached thereto, according to some embodiments. As shown in FIG. 4B, the mounting portion 152 holds the cutting portion, while allowing the cutting portion to rotate along a linear axis. Further, mounting element 152 includes a collection chamber 160, which is in connection with the chamber openings (158A and 158B in FIG. 4A). The collection chamber is configured to collect/hold/store cut hair. In some embodiments, the collection chamber may additionally or alternatively be placed in the handle portion of the shaving apparatus. In some embodiments, cut hair may be moved via the side apertures of the cylindrical screen.

Reference is now made to FIG. 4C, which shows a cross section of a front view of a head portion of a shaving apparatus, according to some embodiments. As shown in FIG. 4C, head portion 150 includes mounting portion 152, onto which cutting portion 102 is attached/mounted. Further shown is the inner surface (having apertures) of cylindrical screen 104, and the blades (exemplary blades 115A-B are shown) of cutting component 112, as well as internal cradle wall 117. Also shown are end elements 108A-108B, which aid in the placement of the cutting portion onto the mounting portion, using suitable hinges and grooves that facilitate positioning and operation of the cutting portion (i.e., allow correct placement, allow rotation of the cylindrical screen, allow liner movement of the cutting component and/or the cradle, and the like). Further shown are collection chamber openings 158A and 158B, which are configured to facilitate the collection of cut hair removed/collected/evacuated from the cutting component, in particular from the cradle cavity region within the cutting component, for example, via suitable apertures on the end face of end elements 108A-108B. In some embodiments, cut hair which accumulates within the cavity of the cutting portion, i.e., on the cradle, is constantly moved to the sides of the cradle, by the linear sideways movement of the cradle together with the cutting component, within the cutting portion, to allow evacuation/exit of the cut hair, via the apertures on the face of the end elements, towards the collection chamber openings 158A and 158B. In some embodiments, the cut hair may fall between the blades of the cutting components, onto the internal cradle. The hair passing through the collection chamber openings may then accumulate in a dedicated collection chamber (160) within the mounting portion 152 and/or within the handle portion 154 of the shaving apparatus.

According to some embodiments, the use of an internal collection cradle (internal cavity), which allows accumulation of cut hair and further dispensing/removal/evacuation of the cut hair to dedicated collection chambers is advantageous, as it enhances the user's experience and allows smooth, efficient shaving/hair removal.

According to some embodiments, at least a portion of the cut hair (for example, at least 20%, at least 30%, at least 40%, at least 50%, at least 60%, at least 70%, at least 80%, at least 90% of the cut hair) is collected in the internal cavity/collection cradle.

According to some embodiments, the cutting component is a rotary cutter is in the form of a hollow cylinder having apertures (organized in a net or lattice structure) on the external circumferences. In some embodiments, the apertures function as cutting edges, as detailed herein.

According to some embodiments, cutting component may be situated in a suitable mounting portion allowing its rotation. In some embodiments, the mounting portion has a shape concurrent to the shape of the rotary cutter, to allow its accommodation and rotation. The casing may further include one or more hinges, axes, and the like, allowing operation (rotation) of the rotary cutter.

According to some embodiments, the rotary cutter cylindrical screen (drum) includes a series of holes/perforations/apertures, that may run along horizontal and/or longitudinal lines.

In some embodiments, the plurality of openings of the cylindrical screen may all have the same shape (for example, a hexagon, an elongated hexagon, and the like), or may have different shapes. In some embodiments, the openings may any shape including circular, triangular, pentagonal, octagonal, or the like. In some embodiments, the openings may have a variation in shape such that some of the openings are circular in shape while others of the openings are polygonal in shape. Thus, the openings can take on any shape so long as they permit a user's hairs to pass through the openings and into the inner cavity for cutting by the cutting component.

According to some embodiments, the cylindrical screen may be made of any suitable material. In some embodiments, the cylindrical screen is made of metal. In some embodiments, the cylindrical screen may be made of aluminum.

In some embodiments, the cutting component may include a plurality of cutting blades that are capable of cutting a user's hair during operation of the shaving apparatus. In some embodiments, cutting component, located within the inner cavity of the cylindrical screen may extends along a cutting axis from a first end to a second end 153. In some embodiments, the cutting components may include a central bore that at least partially extends therethrough. In some embodiments, the mounting portion may include an elongated rod that is located within the central bore for mounting the cutting component to the mounting portion. According to some embodiments, cutting component may move oscillatory or reciprocally during shaving or other hair cutting operations. In some embodiments, the cutting component is caused to oscillate back-and-forth repetitively along a cutting axis. In some embodiments, the cradle may move together with the cutting component.

According to some embodiments, the cutting component (cutting elements) may be made of any suitable material. In some embodiments, the cutting component is made of metal. In some embodiments, the cutting component may be made of aluminum.

According to some embodiments, the cradle may be made of any suitable material and may be rigid, semi-rigid, soft or hard. In some embodiments, the cradle may be made of plastic, metal, rubber, or any combination thereof.

In some embodiments, the shape, dimension and form of the cradle is adjusted to fit the internal cavity of the cutting portion.

According to some embodiments, there is provided a shaving apparatus which generally comprises a handle portion and a head portion. The handle portion is the part that is gripped by a user during shaving and the head portion is the portion that performs the cutting operation and includes a cutting portion and a mounting portion. According to some embodiments, the head portion may be permanently or detachably coupled to the handle portion.

In some embodiments, the shaving apparatus is an electrically operated device that includes a power source and an electric motor that are operably coupled together. In some embodiments, the shaving apparatus may be a manual device. In some embodiments, the power source may be batteries or similar devices that are capable of supplying power to the electric motor. In some embodiments, the power source may be located within the handle portion. In some embodiments, the power source may be located within the head portion or within another component or housing. In some embodiments, the shaving apparatus may not include an internal power source, but may instead include a plug that is configured to be plugged into a wall outlet for powering the electric motor.

In some embodiments, the electric motor may also be located within the handle portion of the shaving apparatus. In some embodiments, the motor may be located within the head portion of the shaving apparatus.

According to some embodiments, the shaving apparatus can further include a power source and motor that are disposed within the handle portion. In some embodiments, the power source and/or motor may be located in the head portion of the shaving apparatus.

In some embodiments, when the shaving apparatus is powered on, power is transmitted from the power source to the motor to rotate the motor, which in turn causes the rotary cutter to rotate and the cutting component to move linearly or oscillate. As shaving apparatus is moved across a user's skin surface (such as on the face or other skin region), the user's hairs are cut due to the interaction or engagement between the cutting edges of the rotary cylindrical screen and the inner cutting component, as detailed herein. Specifically, the user's hairs can be sheared or cut between the cutting edges of the cylindrical screen and the inner blades of the cutting component. The cut hair can then be collected and accumulate within the cavity of the cutting portion, on the inner cradle/collection cell and optionally be removed sideways and evacuate to dedicated collection chamber, via suitable openings, as detailed herein.

According to some embodiments, there is provided a head portion of a shaving apparatus, the head portion includes a cutting portion, the cutting portion includes:
a cylindrical screen having a plurality of openings, an outer surface and an inner surface defining an inner cavity;
a cutting component having one or more cutting elements, the cutting component is positioned adjacent to the inner surface of the cylindrical screen to cut hairs that pass through the openings in the screen; and
an inner cradle positioned within the inner cavity and facing an inner surface of the cutting component, wherein the inner cradle is configured to collect cut hair.

According to some embodiments, there is provided a shaving apparatus which includes a handle portion and a head portion having a cutting portion, the cutting portion includes:
a cylindrical screen having a plurality of openings, an outer surface and an inner surface defining an inner cavity;
a cutting component having one or more cutting elements, the cutting component is positioned adjacent to the inner surface of the cylindrical screen to cut hairs that pass through the openings in the screen; and
an inner cradle positioned within the inner cavity and facing an inner surface of the cutting component, wherein the inner cradle is configured to collect cut hair.

According to some embodiments, there is provided a method of shaving a skin surface, the method includes:
pressing a head portion of a shaving apparatus onto a skin surface, said head portion has a cutting portion, the cutting portion includes:
   a cylindrical screen having a plurality of openings, an outer surface and an inner surface defining an inner cavity;
   a cutting component comprising one or more cutting elements, the cutting component positioned adjacent to the inner surface of the cylindrical screen to cut hairs that pass through the openings in the screen; and
   an inner cradle positioned within the inner cavity and facing an inner surface of the cutting component, said inner cradle is configured to collect cut hair,
such that cut hair is collected in the inner cradle and optionally moved or cleared therefrom to a collection chamber.

In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some exemplary embodiments, “about” may specify the value of a parameter to be between 80% and 120% of the given value, between 90% and 110% of the given value, or between 95% and 105% of the given value.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1-25. (canceled)

26. A head portion of a shaving apparatus, said head portion comprises a cutting portion, said cutting portion comprises:
a cylindrical screen comprising a plurality of openings, an outer surface and an inner surface defining an inner cavity;
a cutting component comprising one or more cutting elements, the cutting component positioned adjacent to the inner surface of the cylindrical screen to cut hairs that pass through the openings in the screen; and
an inner cradle positioned within the inner cavity, said inner cradle is configured to collect cut hair.

27. The head portion according to claim 26, wherein the cutting portion further comprises two end elements comprising one or more apertures on a face thereof, said end elements are positioned perpendicularly to the cylindrical screen, at each end thereof.

28. The head portion according to claim 27, wherein the end elements are substantially round.

29. The head portion according to claim 27, wherein the end elements are essentially similar thereto, in size, shape and/or composition.

30. The head portion according to claim 27, wherein the end elements are in the form of a wheel comprising one or more apertures, whereby the one or more apertures allow the movement or clearance of the cut hair from the cradle in the inner cavity of the cylindrical screen outside of the inner cavity.

31. The head portion according to claim 26, wherein the cylindrical screen is rotatable around a rotational axis, wherein the cylindrical screen comprises an aluminum foil screen.

32. The head portion according to claim 26, wherein the openings of the cylindrical screen are cutting edge openings.

33. The head portion according to claim 26, wherein the cutting portion comprises a gap between the end elements and the cutting component.

34. The head portion according to claim 26, wherein the cutting component comprises a curved cutting foil.

35. The head portion according to claim 34, wherein the curved cutting foil is made of aluminum.

36. The head portion according to claim 26, wherein the cutting component comprises an array of semi-round slice cutter elements having a space therebetween and wherein the cutting component is configured to oscillate along a linear axis to facilitate cutting of the hairs by the cutting elements.

37. The head portion according to claim 26, wherein the cradle is rigid or semi rigid.

38. The head portion according to claim 26, wherein the cradle is made of plastic, metal, rubber, or combinations thereof.

39. The head portion according to claim 26, wherein the inner cradle and the cutting component move or oscillate along a linear axis in a synchronous manner, thereby facilitating movement of the cut hair towards the ends of the cradle.

40. The head portion according to claim 26, further comprising a mounting portion, wherein the cutting portion is configured to be mounted or placed onto said mounting portion and wherein the mounting portion comprises one or more collection chamber openings configured to receive cut hair from the ends of the inner cradle.

41. The head portion according to claim 40, wherein the cutting portion and/or the mounting portion are disposable.

42. A shaving apparatus comprising: a handle portion, the head portion according to claim 27, a motor and a power source.

43. The shaving apparatus of claim 42, wherein the head portion is configured to be reversibly mounted on the handle portion.

44. The shaving apparatus of claim 43, wherein the head portion is disposable.

45. A method of shaving a skin surface, the method comprising:
pressing a head portion of a shaving apparatus onto a skin surface, said head portion comprises a cutting portion, said cutting portion comprises:
a cylindrical screen comprising a plurality of openings, an outer surface and an inner surface defining an inner cavity;
a cutting component comprising one or more cutting elements, the cutting component positioned adjacent to the inner surface of the cylindrical screen to cut hairs that pass through the openings in the screen; and
an inner cradle positioned within the inner cavity and facing an inner surface of the cutting component, said inner cradle is configured to collect cut hair, such that cut hair is collected in the inner cradle and optionally moved or cleared therefrom to a collection chamber.
